(19) United States
(12) Patent Application Publication
(10) Pub. No.: US 2013/0323676 A1
(43) Pub. Date: Dec. 5, 2013

(54) DEVICE FOR CLAMPING CASTS IN DENTAL ARTICULATORS

(71) Applicant: Havid Efren Abdala Pastor, Cartagena (CO)

(72) Inventor: Havid Efren Abdala Pastor, Cartagena (CO)

(21) Appl. No.: 14/000,097

(22) PCT Filed: Feb. 17, 2012
(86) PCT No.: PCT/IB12/00284

§ 371 Date: Aug. 16, 2013

(30) Foreign Application Priority Data
Feb. 18, 2011 (CO) 11-019924

(51) Int. Cl. A61C 11/08

(52) U.S. Cl. CPC A61C 11/08
USPC 433/60

(57) ABSTRACT

The invention relates to a device for mounting and temporarily clamping dental casts using multi-functional receiving formwork elements that secure the dental casts, allowing the ratio measurements to be repeated as many times as desired using telescopic cylinders having a memory unit, said cylinders being manual and/or mechanical with screws and/or pneumatic and/or hydraulic and being used to secure, support and universally calibrate the multi-functional receiving formwork element of the dental articulator, thereby allowing the dental record of the casts to be created.

In present-day dental articulators of nonadjustable, semi-adjustable and totally adjustable type, plaster is generally used to fix the prefabricated dental casts to the plates, they have the task of supporting these casts on the upper and lower branches of the dental articulators; this process means that the labor is considerable, due to the preparation of the quick-setting plaster which is applied between the securing plates of the upper and lower branch of the articulator, since it takes between 30 and 40 minutes when applying the plaster to attach the dental casts in their application location, calibrate the cast, and setting of the plaster, to say nothing of having to start over again when a slight error is present, when one has to again use materials and remove the plates, the dental casts and the plaster, spending more time than initially. This process does not guarantee 100% precision because the plaster during its setting undergoes changes in volume due to the coefficient of linear expansion of 0.3%, depending of the proportions of the mixture of plaster and water.

The purpose of the present invention is to create a dental articulator having a system of telescopic cylinders for the securing of the dental casts that are coupled together, adjust, calibrate and register the exact spatial distances between the base of the branch and the multifunctional receiving formwork element, immobilizing it by the action of adhesives in manual telescopic cylinders, by the filling and draining of oil in hydraulic telescopic cylinders, by the air pressure pumps for pneumatic telescopic cylinders and by servomotors that control the turning of the screws in mechanical telescopic cylinders; it also has a self-adjustable formwork element at its base and at the heads of the various telescopic cylinders, said telescopic cylinder becoming a single piece, allowing these exact measurement elements by the use of control means guided by electronic systems. Generating a unified record of the dental casts for each patient, allowing the creation of the history of the dental records, so as to reproduce the spatial positions of the dental cast assemblies in plaster for each of the patients in the dental articulator.

To better describe the invention, drawings, figures and the claims provided below shall be used.

FIG. 1, shows a perspective schematic representation of the dental articulator

FIG. 2, shows a schematic side view of the dental articulator

FIG. 3, shows a perspective view of a manual, hydraulic and/or pneumatic telescopic cylinder

FIG. 4, shows a perspective schematic representation of the multifunctional formwork element with adjustable tab

FIG. 5, shows a perspective view of the spherical bushing with calibration and adjustment means

FIG. 6, shows a schematic side view of the slide shaft

FIG. 7, shows a perspective view of the spherical bushing 15

FIG. 8, shows a schematic front view of the slide shaft with its two bushings

FIG. 9, shows a lateral perspective view from below of the bushing securing system

FIG. 10, shows an upper lateral perspective view of the base of the multifunctional receiving formwork element carrying the spherical bushing

FIG. 11, shows a lateral perspective view of the upper branch

FIG. 12, shows a lower lateral perspective view of the base of the multifunctional receiving formwork element carrying the spherical bushing

FIG. 13, shows a horizontal lateral perspective view of the support system of the base of the horizontal receiving formwork element carrying the spherical bushing

In FIG. 1 we see a securing unit for casts of dental articulators 1, where the receiving formwork elements 2 are supported by six manual telescopic cylinders 3, which are connected via their ends to the lower branch 6, and its lower branch frame 28, connected by the female spherical couplings 4 to the pin heads 5 located in the multifunctional receiving formwork elements 2 in the lower branch 6 and in its frame 28. The multifunctional receiving formwork elements 2 enabling a manual calibrating and adjusting with the exact location, by the information provided by the facial arch 8, via its holder 9, the manual telescopic cylinders 3 have a groove 10, in which travels the wedge piston 11, to provide resistance to the manual telescopic cylinder 3 when adhesive is added to it, making it static; it furthermore has two slide shafts 12, which connect the base of the lower multifunctional receiving formwork element 13 carrying the spherical bushing to the lower branch base 6, and the other slide shaft 12 connects the upper branch 7 to the base of the upper multifunctional formwork element 14 carrying the spherical bushing; these slide shafts 12 have spherical bushings 15, with bushing press covers 35, where the slide shafts 12 move and are calibrated; they have a fork 16 to strengthen the support and the definitive static position of the multifunctional receiving formwork element 2 during the assembly of dental casts and reproduction of dental movements until the completion of the dentures. The latter is secured by a fork carrying shaft 17, secured in a horseshoe plate 36, supported on the upper branch 7, which fits into the openings 18 of the spherical bushing holder and base of the upper multifunctional receiving formwork element 14. FIG. 2 shows in perspective view a manual telescopic cylinder 3, where one clearly sees the groove 10 of the cylinder 30, allowing the passage of the piston 29, with wedge 11, which is to provide it strength when the telescopic cylinders 3 are calibrated and ready for adding the adhesive. In FIG. 3 we see a perspective view of a telescopic cylinder 19 of hydraulic or pneumatic operation, which expands and contracts to calibrate and support the multifunctional receiving formwork elements 2 during the assembly of dental casts in the dental articulator, equal to and replacing the manual telescopic cylinders in the dental articulator, with the difference that they have electronic control systems for their fixation, calibration and fixation. FIG. 4 shows a telescopic cylinder of mechanical action 20, which has a male thread 32 on its shaft, which screws and unscrews depending on the rotation provided by hand or by servomotors, the hydraulic or pneumatic telescopic cylinders 19 replacing the manual telescopic cylinders 3 inside the dental articulator. FIG. 5 shows in perspective view and in schematic form the multifunctional receiving formwork element 2, along with its platen for plaster casts 21, whose task is to secure and fix the plaster casts; this multifunctional receiving formwork element also has the ability to mold the plaster casts, playing the part of the traditional rubber formwork elements; it is supported on its spherical heads or pins 5, when introduced into the female spherical couplings 4, which are arranged at each end of the different telescopic cylinders 3, 19, 20, which are connected to the pins of the branch 6. FIG. 6 shows in perspective view and in schematic form a multifunctional receiving formwork element with means of connection, securing and rapid fixation of dovetail type 23 to the spherical bushing holder 13 and 14. FIG. 7 shows a perspective view of the spherical bushing 15, by means of the rubber fitting element of the slide shaft 26, which are introduced into the opening 24 which broadly allow the set screw 25 to lock and adjust the slide shafts 12, which also have a slight inclination. FIG. 8 shows a frontal schematic view of the slide shaft with its two adjustable spherical bushings 12, and its corresponding rubber cylinder 34, which are adjusted by their set screws 27. FIG. 9 shows a lateral perspective view from below of the bushing securing system 15, which via the spherical bushing support cover 35 presses the spherical bushing 15 against the lower branch 6, by means of four screws. FIG. 10 shows an upper lateral perspective view of the spherical bushing support base of the multifunctional receiving formwork element 13, where the spherical bushing 15 is coupled when pressed on by the bushing pressing cover 35, by means of four screws. FIG. 11 shows a lateral perspective view of the upper branch 7, with spherical bushing 15, pressed upon by the bushing pressing cover. FIG. 12 shows a lower lateral perspective view of the spherical bushing support base of the multifunctional receiving formwork element 14, pressing the bushing by the bushing pressing cover 35. FIG. 13 shows a horizontal lateral perspective view of the support system of the spherical bushing support base of the horizontal receiving formwork element 13, by means of which it carries as a gradual support a hydraulic or pneumatic telescopic cylinder 19, see FIG. 3, or it can be supported and calibrated with the mechanical telescopic cylinder 20, see FIG. 4, or with the manual telescopic cylinder system 3, see FIG. 2, supported by the spherical bushing 15, of the branch 6.

### LIST OF ELEMENTS WITHIN THE FIGURES

FIG. 1 Cast securing unit of dental articulators

FIG. 2 Multifunctional receiving formwork elements

FIG. 3 Manual adjustment telescopic cylinder with adhesive

FIG. 4 Female concave couplings

FIG. 5 Spherical pin heads

FIG. 6 Lower branch of lower frame

FIG. 7 Upper branch of upper frame

FIG. 8 Facial arch

FIG. 9 Holder

FIG. 10 Groove of manual piston for adhesive

FIG. 11 Groove of the manual adjustment telescopic piston glued in place

FIG. 12 Slide shafts supporting the multifunctional receiving formwork elements

FIG. 13 Lower spherical bushing holder

FIG. 14 Upper spherical bushing holder

FIG. 15 Spherical bushing in perspective view with it adjustment groove

FIG. 16 Reinforcement fork

FIG. 17 Fork support shaft

FIG. 18 Bushing support openings

FIG. 19 Pneumatic or hydraulic telescopic cylinder

FIG. 20 Mechanical telescopic cylinder

FIG. 21 Platen of plaster casts

FIG. 23 Dovetail connection means secured to the bushing holder

FIG. 24 Opening of slide bushing

FIG. 25 Set screw

FIG. 26 Rubber fitting of the slide shaft

FIG. 27 Set screws of slide shafts

FIG. 28 Frame, uprights

FIG. 29 Telescopic piston

FIG. 30 Cylinder

FIG. 32 Threaded piston shaft

FIG. 33 Bushing press cover screws

FIG. 34 Rubber cylinder between bushing and screw

FIG. 35 Bushing press cover

FIG. 36 Horseshoe plate

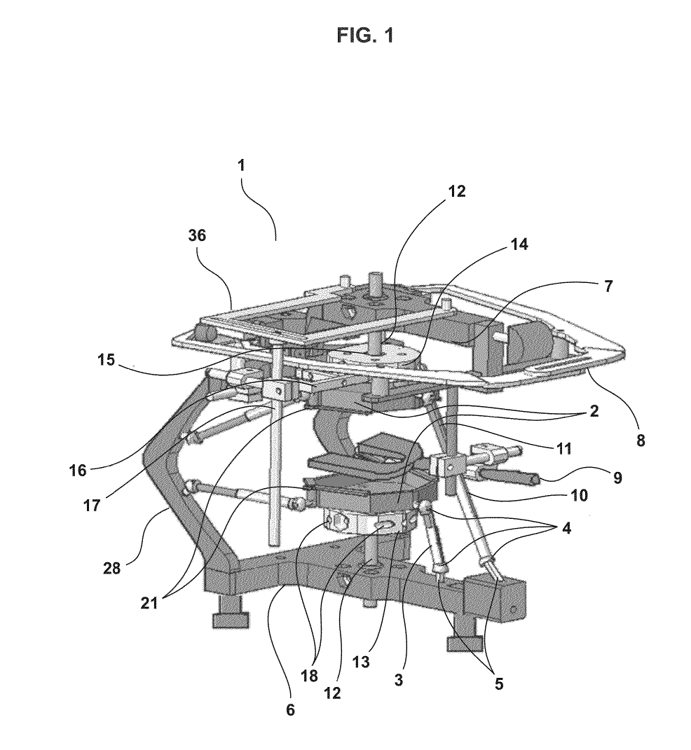

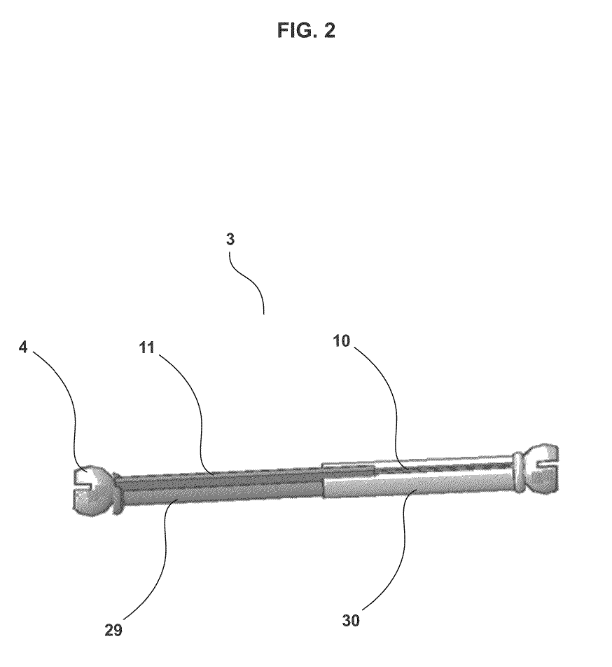

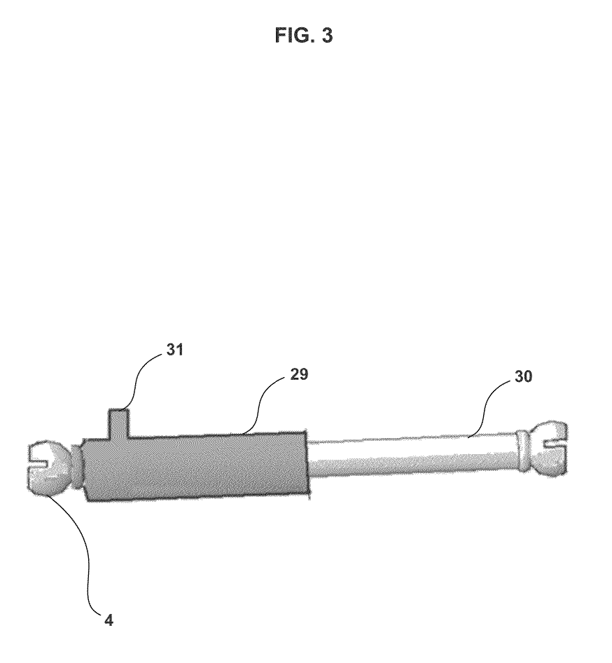

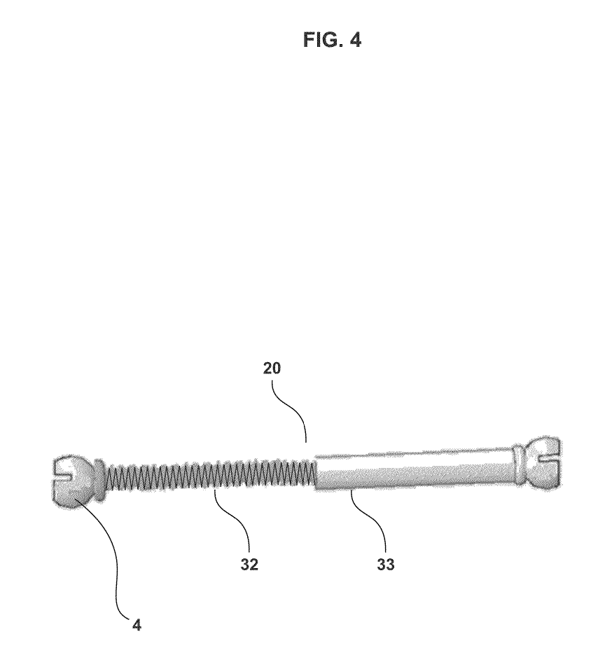

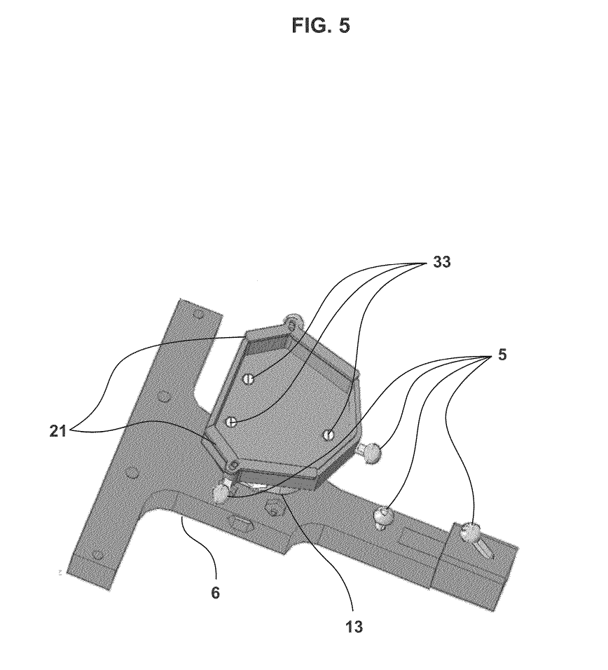

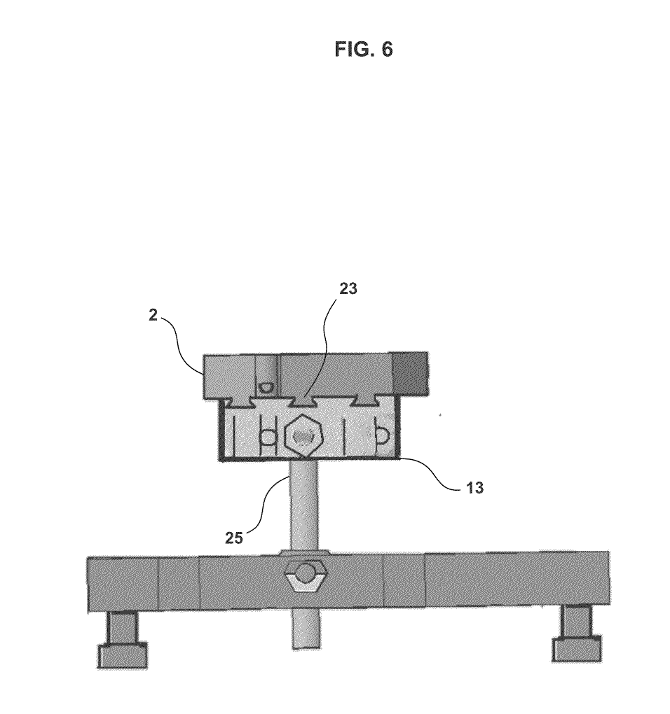

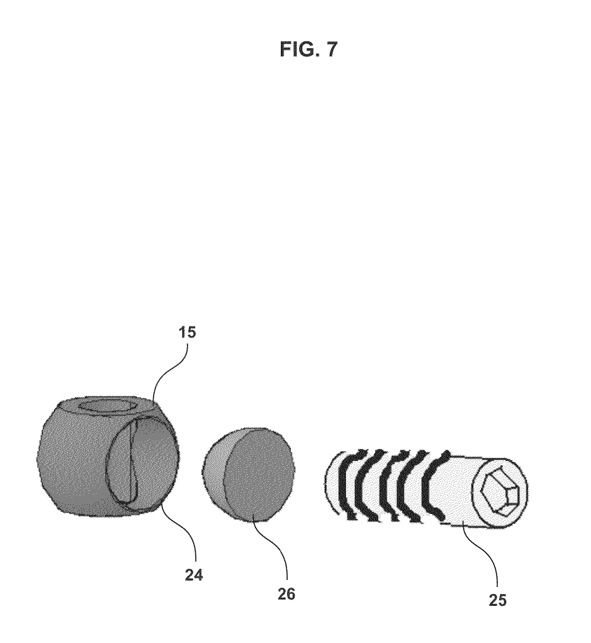

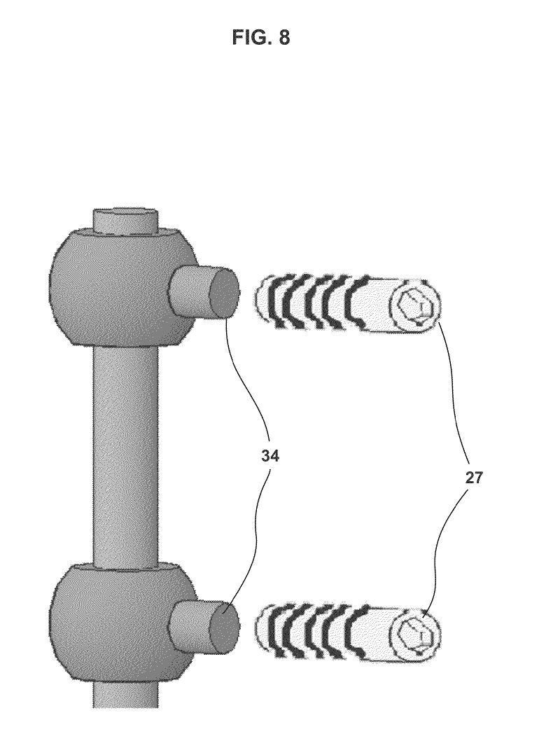

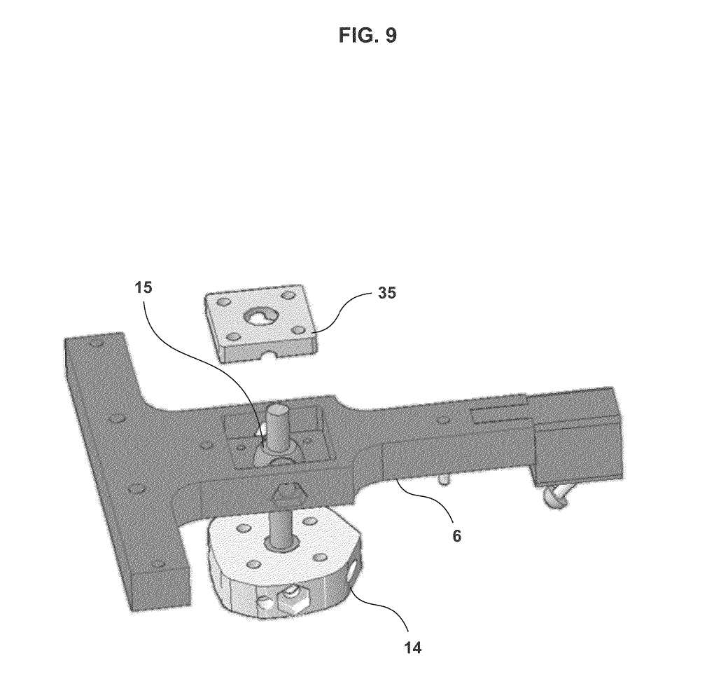

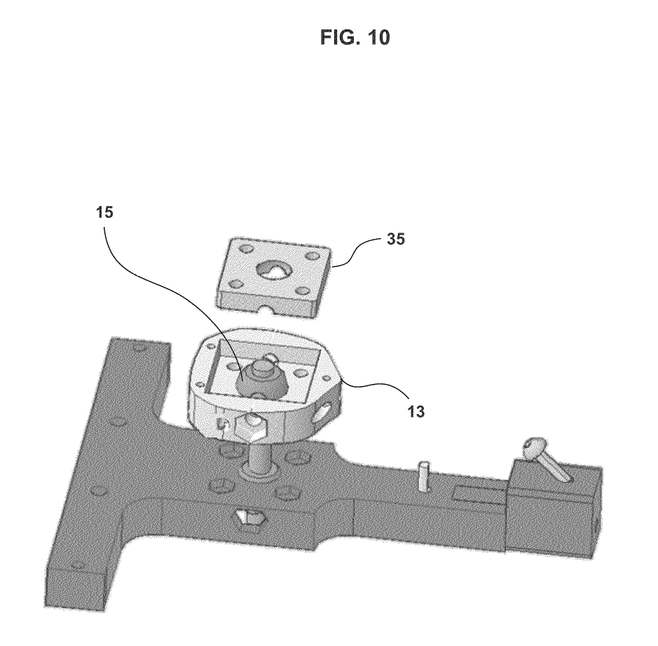

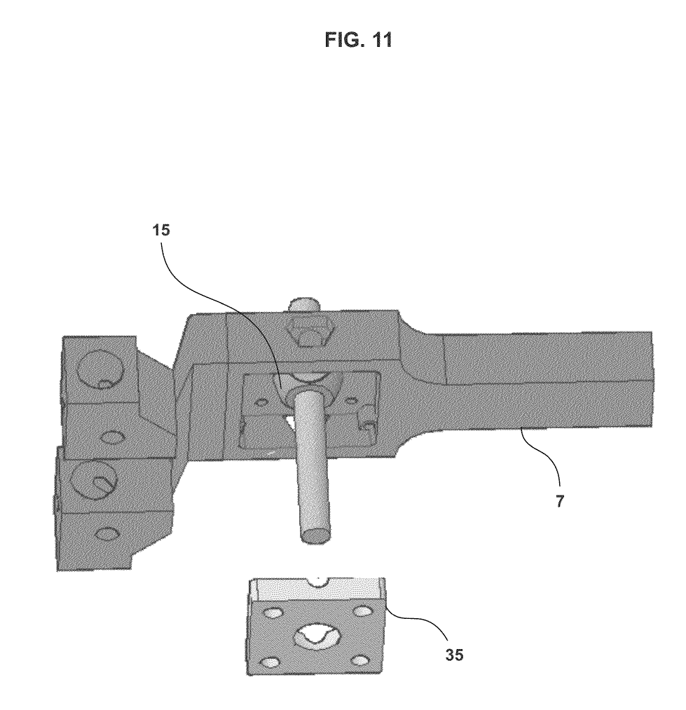

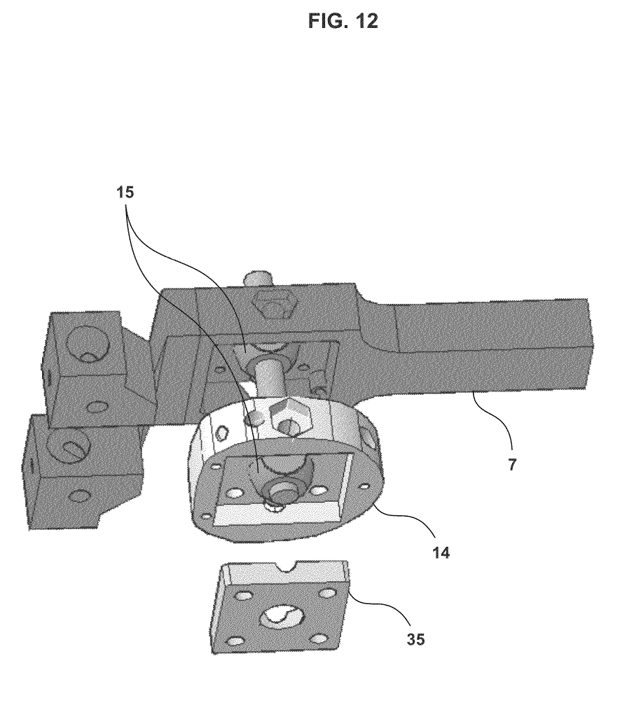

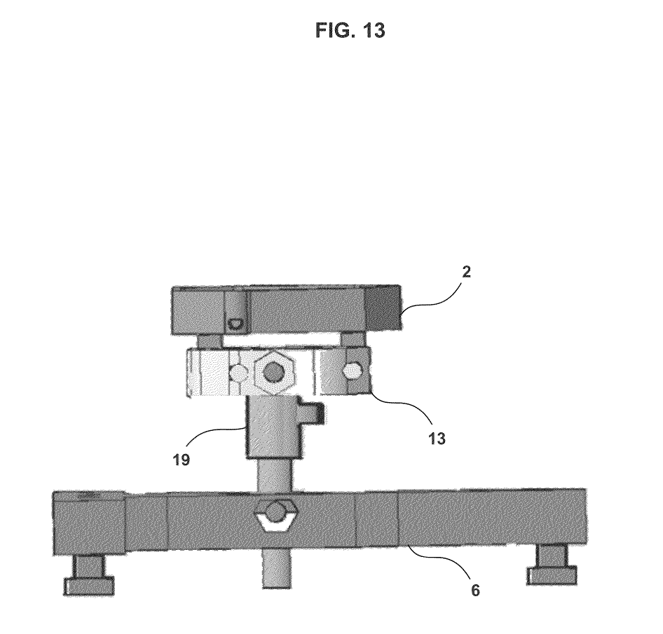

1. Clamping device for casts of dental articulators, characterized in that this device has means of securing and anchoring of its multifunctional receiving formwork elements (2), via manual telescopic cylinders (3), and/or mechanical telescopic cylinders with endless screw (20), and/or hydraulic or pneumatic telescopic cylinders (19), which secure, support and fasten the multifunctional receiving formwork elements (2), where the plaster dental casts are introduced and secured by platens of boomerang shape (21), which are anchored by screws in the edge of the sides of the multifunctional receiving formwork elements (2), which are anchored and supported by the insertion of screws in the bushing support base of the lower (13) and upper (14) formwork elements, and it also has fastening by so-called dovetail fitting quadrants (23), these multifunctional receiving formwork elements (2) carry spherical tip pins (5) that are inserted into the multifunctional receiving formwork elements (2), as well as the lower branch (6), and its frame (28), which are designed to be introduced into the female couplings (4) of the two ends of the different types of telescopic cylinders (3), (19) and (20), which calibrate the multifunctional receiving formwork element when it is connected between the lower branch (6) and the multifunctional receiving formwork element (2), which has supports of two slide shafts (12), upper and lower, which support and slide within the spherical bushings (15), which have fastening means (26), as well as having the spherical bushing (15), with its rubber cylinder (34), as replacement of the central shaft there is installed any other telescopic cylinder of the aforementioned different types (3), (19) and (20), to strengthen the supporting of the multifunctional receiving formwork element (2), through its spherical bushing support base upper formwork element (14), which is supported and secured by the insertion of the fork (16), inside the openings (18), of the bushing support base upper formwork element (14), which is supported by the fork support shaft (17), which in turn is supported by the horseshoe plate arch 36, which is in turn supported on the upper branch (7). Furthermore, it has spherical bushings (15), which are held by rubber cylinders (34), by means of set screws; they have two manual telescopic cylinders (3), for the vertical displacement of the bushing holder bases and (14), instead of the upper and lower slide shafts (12); they have two mechanical telescopic cylinders (20) that operate via servomechanisms, for the vertical displacement of the bushing holder bases (13) and (14), instead of the upper and lower slide shafts (12).

2. Clamping device for casts of dental articulators, according to claim 1, characterized in that the upper and lower multifunctional receiving formwork element (2) is supported, adjusted, calibrated and locked via manual telescopic cylinders (3).

3. Clamping device for casts of dental articulators, according to claim 1, characterized in that the upper and lower multifunctional receiving formwork element (2) is supported, adjusted, calibrated and locked via telescopic cylinders of both hydraulic and pneumatic operation (19).

4. Clamping device for casts of dental articulators, according to claim 1, characterized in that the upper and lower multifunctional receiving formwork element (2) is supported, adjusted, calibrated and locked via mechanical telescopic cylinders with endless screw (20).

5. Clamping device for casts of dental articulators, according to claim 1, characterized in that it has spherical head pins (5), inserted in the multifunctional receiving formwork elements (2) in both the lower branch (6) and its frame (28).

6. Clamping device for casts of dental articulators, according to claim 1, characterized in that the different telescopic cylinders, manual (3), hydraulic or pneumatic (19), mechanical with endless screw (20), have at their ends a system of rapid female spherical couplings with groove (4), where the spherical head pins (5) are introduced.

7. Clamping device for casts of dental articulators, according to claim 1, characterized in that the dental articulator has multifunctional receiving formwork elements (2) where the plaster dental casts are introduced and secured via cast platens in boomerang shape (21), which are anchored by screws in the edge of the sides of the multifunctional receiving formwork elements (2).

8. Clamping device for casts of dental articulators, according to claim 1, characterized in that the multifunctional receiving formwork elements (2) are anchored to and supported by the spherical bushing holder base of the lower (13) and upper (14) formwork elements that connect the multifunctional receiving elements 2, by means of a system of so-called dovetail trapezoidal connecting bars (23).

9. Clamping device for casts of dental articulators, according to claim 1, characterized in that the multifunctional receiving formwork element (2) is secured to the spherical bushing holder base of the lower (13) and upper (14) formwork elements of the multifunctional receiving formwork element by means of screws.

10. Clamping device for casts of dental articulators, according to claim 1, characterized in that the multifunctional receiving formwork element (2) is additionally supported by a fork (16), which is supported on the upper branch (7), via the horseshoe arch (36), which supports the fork holder shaft (17).

11. Clamping device for casts of dental articulators, according to claim 1, characterized in that they have two slide shafts, upper and lower (12), which are supported between the branches (6) and (7), by means of the spherical bushings (15), and the spherical bushing holders of the base of the formwork elements (13) and (14), and they are pressed on by the bushing press cover 35, via four screws.

12. Clamping device for casts of dental articulators, according to claim 1, characterized in that it has spherical bushings (15), which are held by rubber cylinders (34), by means of set screws.

13. Clamping device for casts of dental articulators, according to claim 1, characterized in that they have two manual telescopic cylinders (3), for the vertical displacement of the bushing holder bases and (14), instead of the upper and lower slide shafts (12).

14. Clamping device for casts of dental articulators, according to claim 1, characterized in that they have two telescopic cylinders of both hydraulic and manual operation (19), for the vertical displacement of the bushing holder bases (13) and (14), instead of the upper and lower slide shafts (12).

15. Clamping device for casts of dental articulators, according to claim 1, characterized in that they have two mechanical telescopic cylinders (20) that operate via servomechanisms, for the vertical displacement of the bushing holder bases (13) and (14), instead of the upper and lower slide shafts (12).
